(19) United States
(12) Patent Application Publication
(10) Pub. No.: US 2004/0006505 A1
(43) Pub. Date: Jan. 8, 2004

(54) Strategic and visionary selling of information technology solutions

(76) Inventors: Reinaldo M. Cereseto, Weston, FL (US); Eric R. Brenner, Miami, FL (US); Carlos A. Victoria, Miami, FL (US); Hector G.C. Ramos, Miami, FL (US)

Correspondence Address: PARK, VAUGHAN & FLEMING LLP, 508 SECOND STREET, SUITE 201, DAVIS, CA, 95616, US

(21) Appl. No.: 10/418,657

(22) Filed: Apr. 18, 2003

Related U.S. Application Data
(60) Provisional application No. 60/373,788, filed on Apr. 18, 2002.

(51) Int. Cl. G06F 17/60

(52) U.S. Cl. 705/10

(57) ABSTRACT

One embodiment of the present invention provides a system for strategic and visionary selling of an information technology solution. The system operates by first conducting marketplace research to determine an industry that would benefit from the information technology solution. Next, the system qualifies a prospect within the industry. The system then researches the industry and the prospect to determine the current marketplace position of the prospect within the industry. Next, the system generates a value proposition for a Chief Executive Officer (CEO) of the prospect based on this research. This value proposition identifies benefits of the information technology solution for the prospect. The value proposition is presented to the CEO and approval is obtained from the CEO to conduct a workshop associated with the information technology solution to one or more highest-level executives of the prospect.

### RELATED APPLICATION

This application hereby claims priority under 35 U.S.C. §119 to U.S. Provisional Patent Application No. 60/373,788, filed on Apr. 18, 2002, entitled “Strategic and Visionary Selling Methodology for Information Technology Solutions,” by inventor Reinaldo M. Cereseto. The present application hereby incorporates by reference the above-referenced provisional patent application.

### BACKGROUND

1. Field of the Invention

The present invention relates to selling methodologies. More specifically, the present invention relates to a method and a system for strategic and visionary selling of information technology solutions.

2. Related Art

The market for information technology applications is continually changing and highly competitive. Selling information technology applications in this highly competitive environment can be an extremely challenging task. Software vendors continually attempt to differentiate through products from competing products from other software vendors and consulting firms. This differentiation often involves applying new Internet application solutions and electronic business (e-business) best practices. However, these attempts typically fall far short of desired results.

Existing and historical selling techniques include: “Features and Functions,” “Functions, Benefits, and Advantages,” and “Consultative.” The earliest of these techniques, “Features and Functions,” involves presenting the features and functions of a product to a prospect on a “take it or leave it” basis. This technique typically requires discounting to achieve differentiation from competitors' products.

The “Functions, Benefits, and Advantages” technique involves presenting how the functions, benefits, and advantages of a product can be applied to a prospect's business. While more effective than the “Features and Functions” technique, this technique does not offer great differentiation from competitors' products either.

The most effective currently used technique is the “Consultative” technique. In this technique, the solution provider works with the prospect to analyze requirements. The provider then identifies how its products can add value to the prospect's business. This value includes expected improvements in the prospect's key performance indicators (KPIs), the return on investment (ROI), and the payback period for the investments.

Each of these techniques fails to foresee the impact of external discontinuities in the marketplace, in the industry, and within the business. These techniques, therefore, fail to provide an impetus for transforming the business into a driving force to shape the industry and the marketplace in order to take advantage of a changing marketplace.

Hence, what is needed is a method and a system for selling of an information technology solution without the shortcomings of the above-described techniques.

### SUMMARY

One embodiment of the present invention provides a system for strategic and visionary selling of an information technology solution. The system operates by first conducting marketplace research to determine an industry that would benefit from the information technology solution. Next, the system qualifies a prospect within the industry. The system then researches the industry and the prospect to determine the current marketplace position of the prospect within the industry. Next, the system generates a value proposition for a Chief Executive Officer (CEO) of the prospect based on this research. This value proposition identifies benefits of the information technology solution for the prospect. The value proposition is presented to the CEO and approval is obtained from the CEO to conduct a workshop associated with the information technology solution to one or more highest-level executives of the prospect.

In a variation of this embodiment, the highest-level executives of the prospect can include the CEO, a Chief Operating Officer (COO), a Chief Financial Officer (CFO), a Chief Information Officer (CIO), and other officers designated by the CEO.

In a further variation, the workshop is conducted with these highest-level executives of the prospect, wherein conducting the workshop involves: estimating a value of the information technology solution; estimating an investment required to implement the information technology solution; and producing an architecture and blueprint of the information technology solution as applied to the prospect.

In a further variation, the system identifies and assesses prospective partners for facilitating the information technology solution.

In a further variation, the system selects partners, if necessary for implementing the information technology solution.

In a further variation, the information technology solution is demonstrated to the highest-level executives of the prospect and any additional persons designated by the CEO.

### BRIEF DESCRIPTION OF THE FIGURES

FIG. 1 illustrates a structure for a Strategic and Visionary Selling team in accordance with an embodiment of the present invention.

FIG. 2 presents a flowchart illustrating the process of implementing a Strategic and Visionary Selling process in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

SVS Team

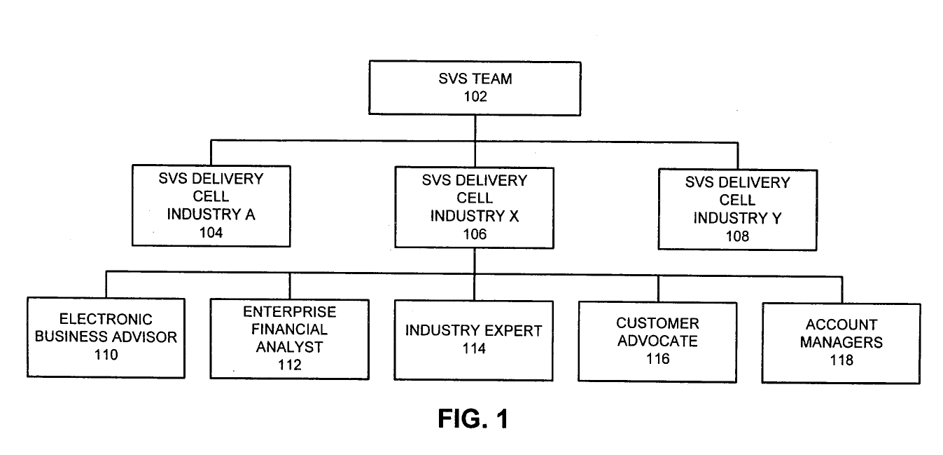

FIG. 1 illustrates a structure for a Strategic and Visionary Selling (SVS) team in accordance with an embodiment of the present invention. SVS team 102 provides the resources and support needed to provide and implement an information technology solution within specific target industries. As is illustrated in FIG. 1, SVS team 102 is organized by industry into SVS delivery cells, such as SVS delivery cell industry A 104, SVS delivery cell industry X 106, and SVS delivery cell industry Y 108.

Each SVS delivery cell is organized in a similar manner; therefore only SVS delivery cell industry X 106 is described in detail herein. SVS delivery cell industry X 106 can include electronic business advisor 110, enterprise financial analyst 112, industry expert 114, customer advocate 116, and account managers 118.

Electronic business advisor 110 provides knowledge and expertise related to electronic business in general and how electronic business can best be implemented on the Internet. To be effective, electronic business advisor 110 maintains a current listing of available programs and methods that relate to electronic business and an analysis of which programs and methods can be used to meet given objectives.

Enterprise financial analyst 112 can perform a complete financial analysis of targeted prospects from within industry X. This financial analysis can include market share, earnings, return on assets, return on equity, economic value added, market value added, and other indicators which can aid the team in preparing an information technology solution.

Industry expert 114 can perform an analysis of, the current state of industry X, the position of a prospect within industry X, and where unrealized potential exists within industry X. Note that industry expert 114 may be an external resource hired on a temporary basis to provide an insight into industry X.

Customer advocate 116 provides a point-of-contact within a prospect, once the prospect has accepted the information technology solution and become a client. Customer advocate 116 assists in delivery of and training for the product and also evangelizes the product within the business.

Account managers 118 provide a point of contact for the customer. A specific account manager is assigned to the account and is responsible for a smooth delivery of the product to the client, and for training the client on the product.

Together, electronic business advisor 110, enterprise financial analyst 112, industry expert 114, customer advocate 116, and account managers 118 provide the expertise and understanding of a prospect's industry and business and can develop an information technology solution to leverage the prospect's electronic business transformation to address industry reinvention, opportunity share, sustainable growth, profitability, market leadership, and to provide shareholders with an exceptional return on investment.

Implementing an SVS Process

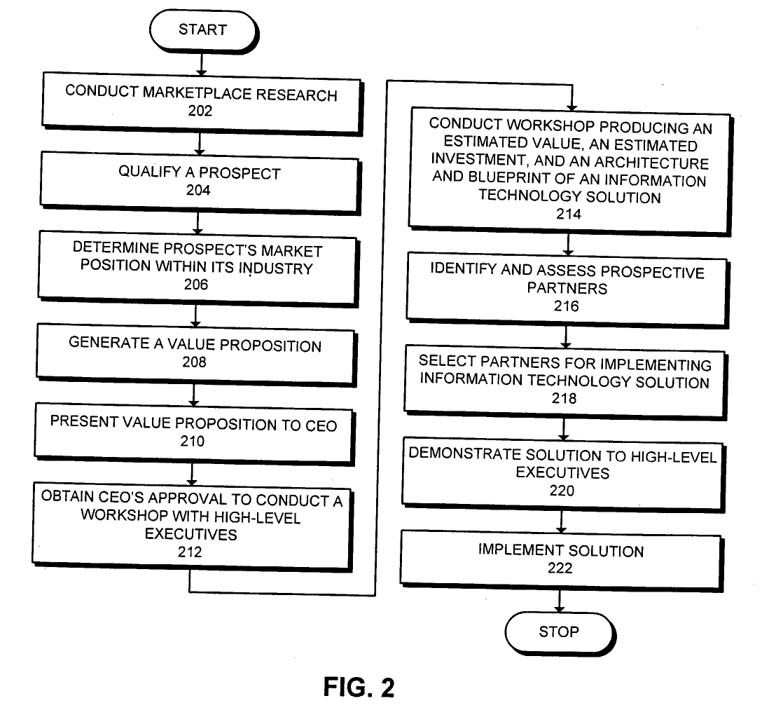

FIG. 2 presents a flowchart illustrating the process of implementing a Strategic and Visionary Selling process in accordance with an embodiment of the present invention. The process starts with marketplace research to identify industries and prospects within these industries that can benefit from an information technology solution (step 202). Next, a prospect is qualified through a thorough analysis of the prospect's business and by identifying the strengths and weaknesses of the prospect (step 204). The prospect's market position within its industry is then determined (step 206).

Information gained through this research is used to generate a value proposition that succinctly depicts the prospect's strengths, weaknesses, and opportunities (step 208). This value proposition is presented to the prospect's Chief Executive Officer (CEO) (step 210). After the value proposition is presented to the CEO, the CEO's approval is hopefully obtained to conduct a workshop with the prospect's high-level executives (step 212). These high-level executives can include the Chief Operating Officer (COO), the Chief Financial Officer (CFO), the Chief Information Officer (CIO) and other officers designated by the CEO.

If the CEO's approval is obtained, the workshop is conducted with the selected high-level executives (step 214). This workshop can produce a number of things, including an estimated value, an estimated investment, and an architecture and blueprint of an information technology solution.

Prospective partners are then identified and assessed to determine advantages and disadvantages of entering a partnership to provide the information technology solution (step 216). Partners can then be selected to implement the information technology solution (step 218). Note that partners are frequently not used.

After the information technology solution has been designed, the information technology solution is presented to the high-level executives and to other persons designated by the CEO (step 220). After a final approval, the information technology solution is implemented (step 222).

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for strategic and visionary selling of an information technology solution, comprising:
conducting marketplace research to determine an industry that would benefit from the information technology solution;
qualifying a prospect within the industry;
researching the industry and the prospect to determine a current marketplace position of the prospect within the industry;
generating a value proposition for a Chief Executive Officer (CEO) of the prospect, wherein the value proposition identifies benefits of the information technology solution;
presenting the value proposition to the CEO; and
obtaining the CEO's approval to conduct a workshop associated with the information technology solution to one or more highest-level executives of the prospect.

2. The method of claim 1, wherein the highest-level executives of the prospect can include the CEO, a Chief Operating Officer (COO), a Chief Financial Officer (CFO), a Chief Information Officer (CIO), and other officers designated by the CEO.

3. The method of claim 1, further comprising conducting the workshop to the one or more highest-level executives of the prospect, wherein conducting the workshop involves:
estimating a value of the information technology solution;
estimating an investment required to implement the information technology solution; and
producing an architecture and blueprint of the information technology solution as applied to the prospect.

4. The method of claim 1, further comprising identifying and assessing prospective partners for facilitating the information technology solution.

5. The method of claim 4, further comprising selecting partners, if necessary, for implementing the information technology solution.

6. The method of claim 5, further comprising demonstrating the information technology solution to the one or more highest-level executives of the prospect and additional persons designated by the CEO.

7. The method of claim 6, further comprising implementing the information technology solution.

8. A means for strategic and visionary selling of an information technology solution, comprising:
a means for conducting marketplace research to determine an industry that would benefit from the information technology solution;
a means for qualifying a prospect within the industry;
a means for researching the industry And the prospect to determine a current marketplace position of the prospect within the industry;
a means for generating a value proposition for a Chief Executive Officer (CEO) of the prospect, wherein the value proposition identifies benefits of the information technology solution;
a means for presenting the value proposition to the CEO; and
a means for obtaining the CEO's approval to conduct a workshop associated with the information technology solution to one or more highest-level executives of the prospect.

9. The means of claim 8, wherein the highest-level executives of the prospect can include the CEO, a Chief Operating Officer (COO), a Chief Financial Officer (CFO), a Chief Information Officer (CIO), and other officers designated by the CEO.

10. The means of claim 8, further comprising a means for conducting the workshop to the one or more highest-level executives of the prospect, wherein conducting the workshop involves:
estimating a value of the information technology solution;
estimating an investment required to implement the information technology solution; and
producing an architecture and blueprint of the information technology solution as applied to the prospect.

11. The means of claim 8, further comprising a means for identifying and assessing prospective partners for facilitating the information technology solution.

12. The means of claim 11, further comprising a means for selecting partners, if necessary, for implementing the information technology solution.

13. The means of claim 12, further comprising a means for demonstrating the information technology solution to the one or more highest-level executives of the prospect and additional persons designated by the CEO.

14. The means of claim 13, further comprising a means for implementing the information technology solution.

15. A process for strategic and visionary selling of an information technology solution, comprising:
examining an opportunity to add value to a business through using the Internet;
creating the information technology solution to exploit the opportunity; and
implementing the information technology solution.

16. The process of claim 16, wherein examining the potential to add value to the business through using the Internet involves considering, industry reinvention cycles, environmental discontinuities, market trends and needs, competitors, current competencies, efficiencies, and financial health in view of the Internet as a main driver of change.

17. The process of claim 16, wherein creating the information technology solution to exploit the opportunity involves:
foreseeing a potential role for the business in the future; and
determining how to leverage a transformation that will improve the business by taking advantage of the internet.

18. The process of claim 17, wherein determining how to leverage the transformation includes identifying and assessing potential partners to assist in exploiting the opportunity to add value to the business.

19. The process of claim 18, further comprising selecting partners, if necessary, to assist in realizing the potential to add value to the business.

20. The process of claim 19, further comprising implementing the information technology solution within the business.
